(19) United States
(12) Patent Application Publication
(10) Pub. No.: US 2008/0063997 A1
(43) Pub. Date: Mar. 13, 2008

(54) LIGHTED DENTAL CLEANER

(76) Inventors: John M. Jansheski, Maryville, TN (US); Lex Shankle, Maryville, TN (US)

Correspondence Address: LUEDEKA, NEELY & GRAHAM, P.C., P O BOX 1871, KNOXVILLE, TN, 37901, US

(21) Appl. No.: 11/465,603

(22) Filed: Aug. 18, 2006

(51) Int. Cl. A61C 1/00; A61C 15/00

(52) U.S. Cl. 433/29; 132/328

(57) ABSTRACT

A dental cleaning device includes a handle portion and a cover portion. The handle portion provides a dental cleaning tool, such as a dental pick or a dental scaler, and an illumination source, such as one or more light emitting diodes (LEDs). The illumination source directs light toward the end of the dental cleaning tool so that the light is always pointed exactly where it is needed during a dental cleaning procedure. The cover portion may include a mirror which further aids a user in viewing the dental cavity while using the dental cleaning tool. The cover portion is configured to attach to the handle portion to enclose the dental cleaning tool when the dental cleaning tool is not in use.

### FIELD

This invention relates to the field of dental cleaning devices. More particularly, this invention relates to a dental cleaning apparatus which in one embodiment includes a mirror, a cleaning device and an illumination source configured to illuminate portions of the cleaning device during use at the site of interest.

### BACKGROUND

Situations often arise wherein a person needs to remove food particles, tarter and general debris from teeth using a dental cleaning device, but there is no mirror or adequate lighting available to aid in seeing the area needing attention. In such situations, the person must either make do with no light or mirror, or the person must seek out a restroom or other facility where a light and mirror may be available.

What is needed, therefore, is a device which facilitates inspection of the mouth by providing illumination, and which can be used to remove food particles, tarter and general debris from the teeth and to clean the teeth. Such a device having an integrated mirror is also needed.

### SUMMARY

The above and other needs are met by a dental cleaning apparatus comprising a handle portion and a cover portion. The handle portion includes a handle portion housing, a dental cleaning tool and an illumination source. The dental cleaning tool may be a pick or a scaler or other such cleaning tools. The illumination source preferably comprises one or more light emitting diodes (LEDs). The cover portion is configured to attach to the handle portion to enclose the dental cleaning tool when the dental cleaning tool is not in use. The cover portion includes a cover portion housing, a cavity for receiving the dental cleaning tool and a mirror attached to the cover portion housing. The dental cleaning tool has a proximal portion attached to the handle portion housing and a distal portion extending outward from the handle portion housing. The illumination source, which is disposed in the handle portion housing, generates light which is directed to the distal portion of the dental cleaning tool and to the site of interest.

In preferred embodiments, an electrical switch is provided in the handle portion which is operable by a user to selectively activate and deactivate the illumination source. The handle portion houses a controller that is electrically coupled to the illumination source. In a preferred embodiment, the controller automatically deactivates the illumination source after a predetermined period of time to conserve battery power.

The handle portion housing and the cover portion housing are preferably formed of injection-molded thermoplastic materials. The cover portion preferably includes a channel through the housing that allows light emanating from the illumination source to pass through the cover portion when the cover portion is attached to the handle portion. In this manner, the device may be used as a flashlight when it is not being used as a dental cleaning device.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIGS. 1A and 1B are perspective views of a dental cleaning apparatus according to a preferred embodiment of the invention;

FIG. 2 is an exploded view of a dental cleaning apparatus according to a preferred embodiment of the invention;

FIGS. 3A-3F are top, side and bottom views of a dental cleaning apparatus according to a preferred embodiment of the invention; and

FIG. 4 is a schematic diagram of an electrical circuit used in a preferred embodiment of the invention.

### DETAILED DESCRIPTION

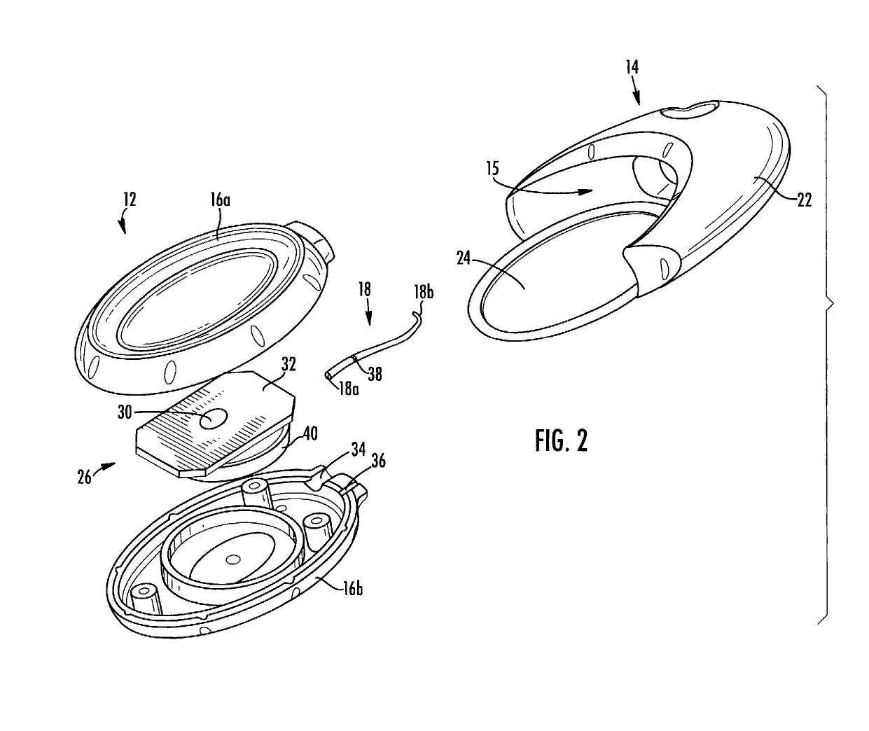

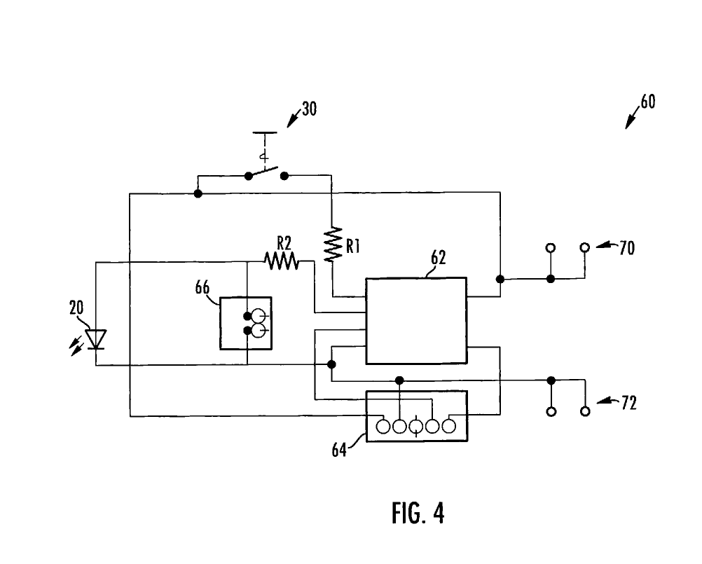

As depicted in the drawings, a preferred embodiment of the invention provides a dental inspection and cleaning apparatus 10 comprising a handle portion 12 and a removable cover portion 14. The handle portion 12 includes a housing 16, a dental cleaning tool 18, and an illumination source 20 for directing light toward a distal end 18b of the dental cleaning tool 18. A switch 30 and an associated electrical circuit 26 (FIGS. 2 and 4) enable a user to selectively activate the illumination source 20. The dental cleaning tool 18 may be any of a variety of dental tools, such as but not limited to scalers, picks and the like, which are configured for precise interaction with the teeth of a user. The cover portion 14 includes a built-in mirror 24 that may be used in conjunction with the illumination source 20 to view the inside of the dental cavity of the user.

In this regard, it is noted that the illumination source 20 is advantageously configured to direct light at the point of interaction of the distal end 18b of the dental tool 18 with the teeth or tooth of a user to enhance visibility of the working portion of the dental tool 18 at the site of interest. Thus, a user with the aid of the mirror 24 may achieve improved visibility of the locations to be cleaned or otherwise interacted with by the dental tool 18. For example, when attempting to dislodge a popcorn kernel, a user may have difficulty locating the edge of the kernel with a pick by feel alone or without illumination. Thus, by utilizing the device of the disclosure, a user may, with the aid of the mirror 24, more easily illuminate and view the distal end 18b of the dental tool 18 and more easily determine when the distal end 18b is adjacent the edge of the kernel.

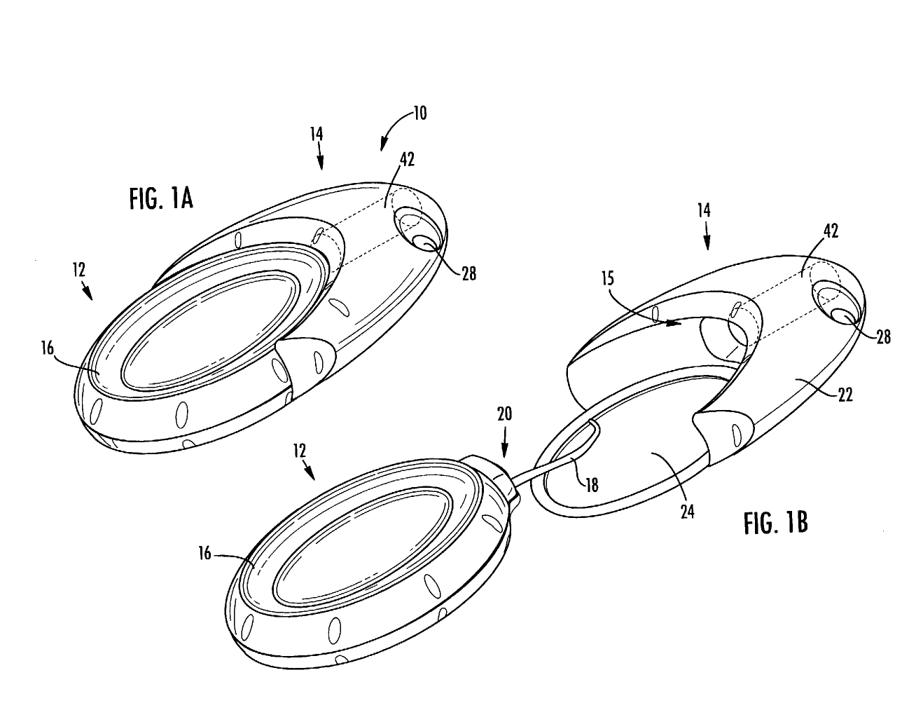

As shown in FIGS. 1A and 1B, the cover portion 14 may be engaged with the handle portion 12 in a snap-fit configuration (FIG. 1A) or separated from the handle portion 12 (FIG. 1B). The cover portion 14 comprises a housing 22 which forms a cavity 15 that receives the dental tool 18 when the cover portion 14 engages the handle portion 12. This feature protects the dental tool 18 from damage when not in use, and prevents accidental injury to the user or others. When the cover portion 14 is disengaged from the handle portion 12, a user may hold the cover housing 22 in one hand and position the mirror 24 for viewing the inside of the dental cavity. At the same time, the user may hold the housing 16 of the handle portion 12 in the other hand to manipulate the dental tool 18 to dislodge food particles.

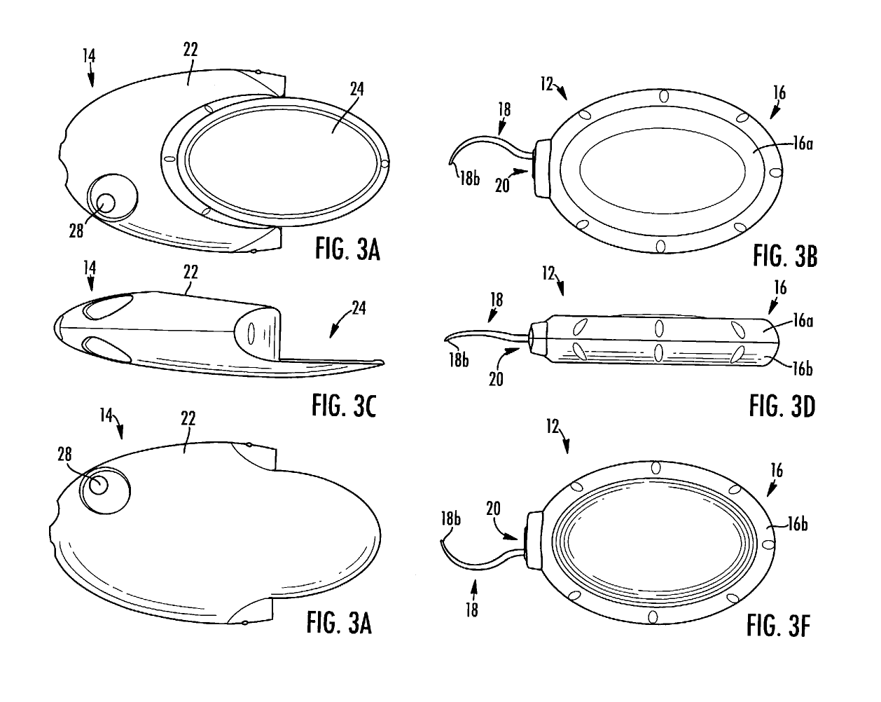

As shown in FIG. 1B, a preferred embodiment of the housing 22 includes a molded-in channel 42 which aligns with the illumination source 20 when the cover portion 14 is engaged with the handle portion 12. This channel 42 allows the light emanating from the illumination source 20 to pass through the housing 22. In this manner, even when the cover portion 14 engages the handle portion 12 to cover the dental tool 18, light from the illumination source 20 may pass through the channel 42 so that the device 10 may be used as a flashlight. The mirror 24 is preferably retained in the housing 22 by over-molding. However, it will be appreciated that the mirror 24 may also be retained using an adhesive or other means. As shown in FIGS. 1A, 1B, 3A and 3E, the cover portion 14 preferably includes an aperture 28 in the housing 22 through which a lanyard or keychain may be attached.

With reference to FIG. 2, the preferred embodiment of the housing 16 of the handle portion 12 includes an upper housing 16a and a lower housing 16b, each of formed of molded plastic and configured to have crush pins and corresponding cylinders for snap-fit construction. The exterior surfaces of the housing 16 preferably includes over-molded portions made of an elastomeric material, such as thermoplastic elastomeric (TPE) resins, for aesthetics and to enhance gripping by a user. A variety of plastics of the type used to make thin-wall handles may be used to make the upper and lower housings 16a and 16b, including flexible polyolefin plastics and the like.

Sandwiched between the housings 16a and 16b is the electrical circuit 26, which preferably comprises a printed circuit board 32, one or more batteries 40 and associated wiring leading from the board 32 to the illumination source 20.

When the upper and lower housings 16a and 16b are snapped together to form the handle portion 12, opposing molded channels 34 and 36 in the upper and lower housings come together to form a large aperture and a small aperture. The illumination source 20 is disposed within the large aperture and the shank 18a of the dental tool 18 is retained within the small aperture.

The dental tool 18 is preferably of configured as a so-called explorer pick for dislodging food and other debris from between teeth and around the gums. In an alternative embodiment, the dental tool 18 is a scaler for removing tartar and plaque. The tool 18 preferably includes a circumferential groove 38 in the shank 18a which is configured mate with a protrusion on the inside of the channels 36 to frictionally capture the shank 18a of the tool 18 between the upper and lower housings 16a and 16b. In this regard, the groove 38 and/or the adjacent edges of the shank 18a and the channel 36 may have cooperating topographies to substantially lock the tool 18 in position and resist rotation during use. An adhesive or the like may also be used to retain the dental tool 18 within the housing 16. The tool 18 is preferably of stainless steel construction, but may be of other construction, such as molded plastic.

The illumination source 20 is preferably a light emitting diode (LED) configured and fixedly positioned, as by use of adhesive or a friction fit, within the larger aperture between the upper and lower housings 16a and 16b of the handle portion 12. By operation of the switch 30, the illumination source 20 selectively provides light directed to a tip portion 18b of the dental tool 18. A preferred LED has a luminous intensity of about 1 candela. As explained in more detail below, a user may operate the switch 30 by pressing a predetermined location on the handle 12, it being understood that the plastic utilized to make the handle 12 is sufficiently flexible to permit the switch 30 to be operated by pressing on a portion of the handle 12 immediately adjacent the switch 30. Alternatively, the switch may extend outside the surface of the handle 12. However, it is preferred that the handle 12 comprise a substantially sealed structure so as to be unaffected as by rinsing with water and the like.

With reference to FIG. 4, there is shown a schematic of a preferred embodiment of an electrical circuit 60 for controlling activation of the illumination source 20. The circuit 60 includes a microprocessor controller 62, such as a “programmable system on a chip” (PSOC) having model number CY8C21123-24SXI manufactured by Cypress. The controller 62 enables use of a momentary dome switch device for the switch 30, such as part number F12340 manufactured by Snaptron. Not only does the controller 62 selectively activate the illumination source 20, but it may also automatically shut it off after a predetermined time to conserve battery power. In the preferred embodiment, the illumination source 20 is configured for illumination purposes and is preferably a white (visible) light LED, such as part number 67-1690-ND manufactured by Lumex, which is received in connection port 66. The circuit 60 may include a programming port 64 for programming the controller 62. Positive and negative battery terminals 70 and 72 are provided for connection of the one or more batteries 40 (FIG. 2). In a preferred embodiment of the circuit 60, the resistor R1 has a value of 50 KΩ, and the resistor R2 has a value of 50 Ω.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A dental cleaning apparatus comprising:
a handle portion comprising:
a handle portion housing;
a dental cleaning tool having a proximal portion and a distal portion, the proximal portion attached to the handle portion housing at a first location and the distal portion extending outward from the handle portion housing; and
an illumination source disposed in the handle portion housing at a second location laterally spaced apart from the first location, the illumination source for generating light directed toward the distal portion of the dental cleaning tool; and
a cover portion configured to attach to the handle portion to enclose the dental cleaning tool when the dental cleaning tool is not in use, the cover portion comprising:
a cover portion housing configured to engage the handle portion housing when the cover portion is attached to the handle portion; and
a cavity within the cover portion housing for receiving at least the distal portion of the dental cleaning tool when the cover portion housing engages the handle portion housing.

2. The dental cleaning apparatus of claim 1 wherein the cover portion further comprises a mirror attached to the cover portion housing.

3. The dental cleaning apparatus of claim 1 wherein the dental cleaning tool is selected from the group consisting of a dental pick and a dental scaler.

4. The dental cleaning apparatus of claim 1 wherein the handle portion further comprises an electrical switch operable by a user to selectively activate and deactivate the illumination source.

5. The dental cleaning apparatus of claim 1 wherein the handle portion further comprises a controller electrically coupled to the illumination source for automatically deactivating the illumination source after a predetermined period of time.

6. The dental cleaning apparatus of claim 1 wherein the illumination source comprises one or more light emitting diodes.

7. The dental cleaning apparatus of claim 1 wherein the handle portion housing comprises an upper housing and a lower housing, wherein the proximal portion of the dental cleaning tool is retained between the upper housing and the lower housing.

8. The dental cleaning apparatus of claim 1 wherein the cover portion includes a channel passing substantially through the cover portion housing, the channel substantially aligned with the illumination source when the cover portion is engaged with the handle portion, the channel for aiding in directing light from the illumination source through the cover portion housing.

9. A dental cleaning apparatus comprising:
a handle portion comprising:
a handle portion housing comprising an upper housing and a lower housing;
a dental cleaning tool selected from the group consisting of a dental pick and a dental scaler, the dental cleaning tool having a proximal portion retained between the upper housing and the lower housing at a first location of the handle portion, the dental cleaning tool having a distal portion extending outward from the handle portion housing;
one or more light emitting diodes disposed in the handle portion housing at a second location of the handle portion laterally spaced apart from the first location, the one or more light emitting diodes for generating light directed toward the distal portion of the dental cleaning tool;
an electrical switch operable by a user to selectively activate and deactivate the one or more light emitting diodes;
a controller electrically coupled to the one or more light emitting diodes and the electrical switch for automatically deactivating the one or more light emitting diodes after a predetermined period of time: and
a cover portion configured to attach to the handle portion to enclose the dental cleaning tool when the dental cleaning tool is not in use, the cover portion comprising:
a cover portion housing configured to engage the handle portion housing when the cover portion is attached to the handle portion;
a cavity within the cover portion housing for receiving at least the distal portion of the dental cleaning tool when the cover portion housing engages the handle portion housing; and
a mirror attached to the cover portion housing.

10. A dental cleaning apparatus comprising:
means for holding the dental cleaning apparatus in a hand of a user, the means for holding comprising:
a first housing;
means for cleaning teeth including a distal portion extending outward from a first location of the first housing; and
means for illuminating the distal portion of the means for cleaning teeth, the means for illuminating being located at a second location of the first housing laterally spaced apart from the first location; and
means for covering the means for cleaning teeth when the means for cleaning teeth are not in use, the means for covering comprising:
a second housing configured to engage the first housing when the means for covering is attached to the means for holding; and
means for receiving at least the distal portion of the means for cleaning teeth when the second housing engages the first housing.

11. The dental cleaning apparatus of claim 10 wherein the means for covering further comprises a mirror attached to the second housing.

12. A dental cleaning apparatus, comprising:
a handle having a light located at a first location thereon and a dental pick extending from a second location of the handle laterally spaced apart from the first location, the light being located to direct light from the first location toward a distal portion of the dental pick; and
a cover configured to engage the handle when the cover is attached to the handle, the cover including an interior cavity for receiving at least the distal portion of the dental pick, with a mirror located within the interior cavity.
